(19) United States
(12) Patent Application Publication
(10) Pub. No.: US 2009/0300395 A1
(43) Pub. Date: Dec. 3, 2009

(54) POWER SAVING SYSTEM AND METHOD

(75) Inventors: Chung-Ta Chin, Taipei City (TW); Pei-Hua SUN, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei City (TW)

(21) Appl. No.: 12/233,891

(22) Filed: Sep. 19, 2008

(30) Foreign Application Priority Data
Jun. 3, 2008 (TW) 97107856

(51) Int. Cl. G06F 1/32

(52) U.S. Cl. 713/324

(57) ABSTRACT

A power saving system is provided, comprising a system chip, at least one controller and at least one corresponding switch. The system chip is coupled to the controller. The controller is coupled between the system chip and a connector. The switch is coupled between the controller and a power and is turned on or off according to a GPIO signal. When the switch is turned on, the controller is active. When there is no device through the connector and the controller coupled to the system chip, the controller is turned off for power saving.

### CROSS REFERENCE TO RELATED APPLICATIONS

This Application claims priority of Taiwan Patent Application No. 097107856, filed on Mar. 6, 2008, the entirety of which is incorporated by reference herein.

### BACKGROUND OF THE INVENTION

1. Field of the Invention

The invention relates to a power saving circuit, and more particularly, to a power saving circuit applied in computer systems.

2. Description of the Related Art

In a conventional computer system, all peripheral devices will be waked up when powered on. In other words, all controller chips corresponding to the peripheral devices will also be activated for operation.

However, users may not utilize all of the computer peripheral devices all the time or users may only utilize some computer peripheral devices during a specific time period. The peripheral devices which are not frequently used and controller chips corresponding thereto, however, still consume power, thus causing the conventional computer systems to inefficiently utilize and waste power.

Five ACPI (Advanced Configuration and Power Interface) states, such as S0, S1, S3, S4 and S5 states, are commonly utilized in computer systems. However, computer systems can only normally operate in the S0 state, while computer systems enter a sleep state in the S1-S5 states. Thus, while computer system power can be saved, computer system operation is inconvenient.

### BRIEF SUMMARY OF THE INVENTION

A power saving method for use in an electronic system is disclosed, wherein the electronic system comprises at least one controller respectively connecting to at least one peripheral device. The method comprises the following steps. First, whether any of the peripheral devices is coupled to the respective controllers is detected. The controller is powered off by the electronic system when no peripheral device is coupled to the respective controllers. A device configuration table is updated and next peripheral device is continuously detected.

A power saving system for determining whether a peripheral device being coupled thereto for power saving control is further disclosed, comprising a system chip, a controller coupled to the system chip and a switch. When the system detects that the controller is not connect to the peripheral device, the GPIO port sends a control signal to the switch such that the switch turns off a power supplied to the controller for power saving.

### BRIEF DESCRIPTION OF THE DRAWINGS

The invention can be more fully understood by reading the subsequent detailed description and examples with reference to the accompanying drawings, wherein:

FIG. 1 is a flowchart showing an embodiment of a power saving method according to the invention; and

FIG. 2 shows another embodiment of a power saving system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

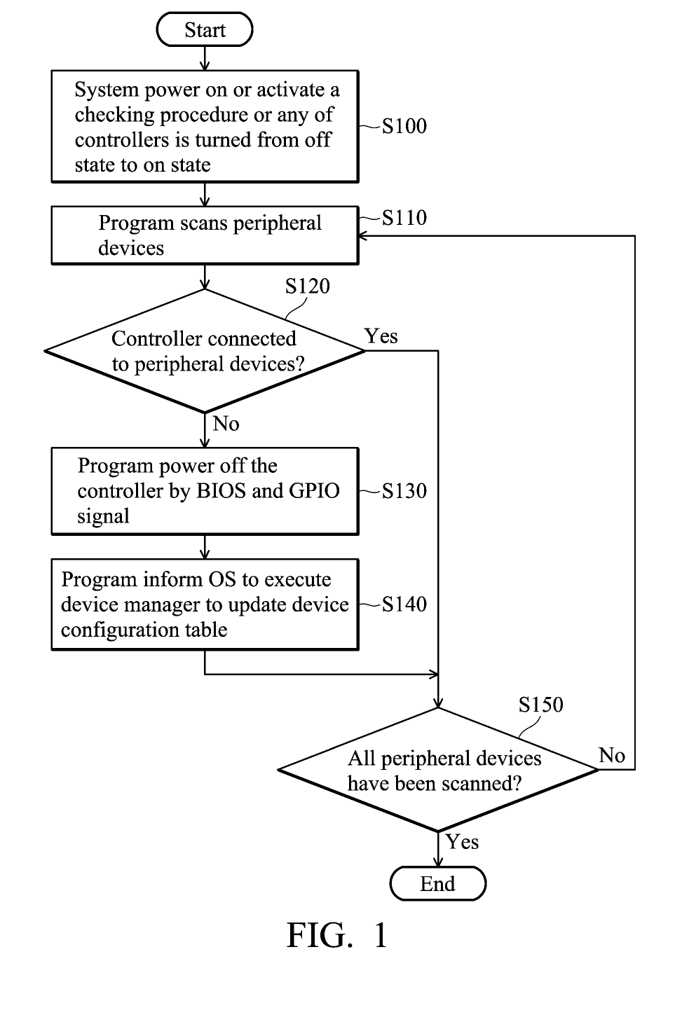

FIG. 1 is a flowchart showing an embodiment of a power saving method according to the invention. According to one embodiment of the invention, when the electronic system is powered on and activates all of the controllers or activates a checking procedure or the state of any of the controllers is turned from a turned-off state to a turned-on state (step S100), a checking procedure may be performed by performing an AP (application program) for scanning (i.e. detection) after a control button is pressed by a user. The checking procedure may also be performed by performing an AP for scanning after a screen option has been selected by a user. The AP would then scan whether one of the peripheral devices through a connector coupled to a corresponding controller exists (step S110), and determine whether the peripheral device is coupled to the controller (step S120). If a peripheral device is coupled to the corresponding controller, the corresponding controller is activated. If the peripheral device is not coupled to the corresponding controller, the AP outputs a control signal to a switch through the BIOS (Basic Input Output System) and a GPIO (General purpose input/output) port so that the switch forces the power of the corresponding controller to be turned off for power saving (step S130) and the AP informs the OS (Operation System) to perform a DM (Device Manager) program to update a device configuration table (step S140). Then, it is determined whether all of the peripheral devices have been scanned (step S150). If any of the peripheral devices have not scanned, the flow returns to step S110. In another embodiment, the electronic system may utilize hardware to scan and determine whether the peripheral device is coupled to the electronic system, and is not limited to only utilizing the AP.

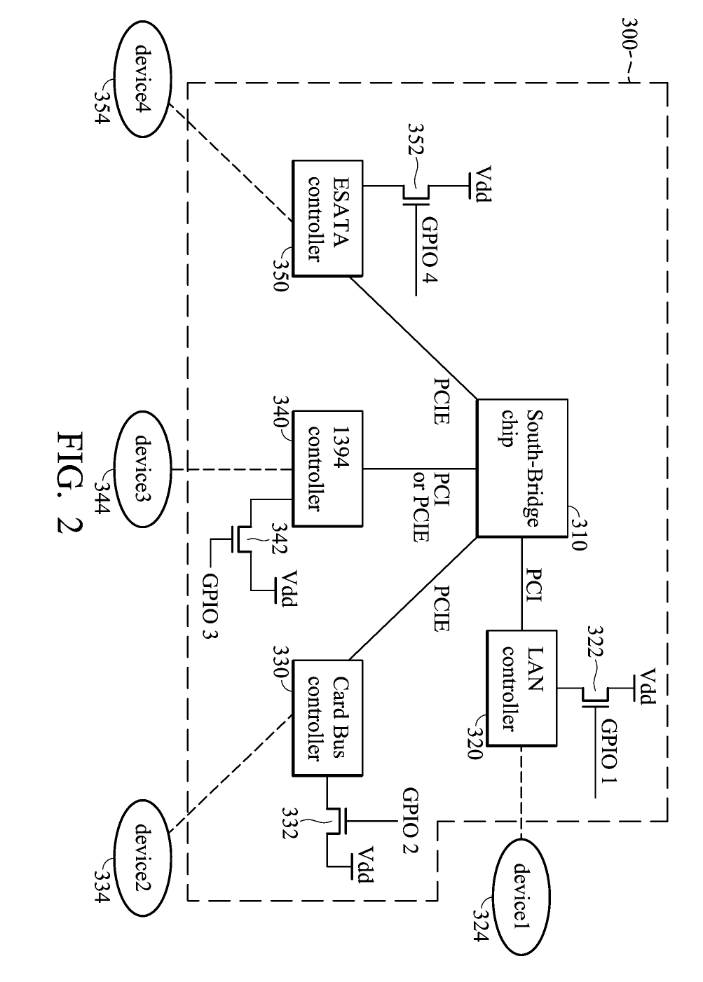

FIG. 2 shows another embodiment of a power saving system 300 according to the invention. The power saving system 300 comprises a South-Bridge chip 310, pluralities of controllers, such as LAN controller 320, Card Bus controller 330, 1394 controller 340, ESATA (External Serial ATA) controller 350, pluralities of corresponding switches 322, 332, 342 and 352 and pluralities of corresponding computer peripheral devices 324, 334, 344 and 354, respectively. As shown in FIG. 3, the South-Bridge chip 310 is connected to the LAN controller 330 through a PCI bus, connected to the 1394 controller 340 through the PCI or a PCI express bus, and connected to the ESATA controller 350 through the PCI express bus. Each of the controllers 320, 330, 340 and 350 comprises a connector (not shown), and the controllers 320, 330, 340 and 350 are connected to the peripheral devices 324, 334, 344 and 354 respectively through the corresponding connector. Each of the controllers 320, 330, 340 and 350 are coupled to a supplied power Vdd through the switches 322, 332, 342 and 352 respectively.

In one embodiment of the invention, each of the switches 322, 332, 342 and 352 is coupled between a supplied power Vdd and the corresponding controller, and each switch is turned on or off according to a GPIO signal. For example, the switch 322 is turned on or off according to a GPIO signal GPIO1. When the device 324 is connected to the controller 320 through the connector, the GPIO signal GPIO1 is at a high voltage level such that the NMOS transistor 322 is turned on and the LAN controller 320 is activated due to reception of the supplied power Vdd. The South-Bridge chip 310 thus connects to the LAN controller 320 through the PCI interface and the LAN controller 320 and starts transmitting data to/receiving data from therebetween. When the device 324 is not connected to the South-Bridge chip 310 through the connector and the LAN controller 320, the AP will issue a GPIO signal GPIO1 to turn off the switch 322 thereby powering off the LAN controller 320 for reducing power consumption.

When the device 334 is not connected to the South-Bridge chip 310 through the connector and the Card Bus controller 330, the AP will issue a GPIO signal GPIO2 to turn off the switch 332 thereby powering off the Card Bus controller 330 for reducing power consumption. Similarly, when the 1394 controller 340 and the ESATA controller 350 are not being used, i.e. both the peripheral devices 344 and 354 are not connected to the controllers 340 and 350, the AP will issue GPIO signals GPIO3 and GPIO4 to turn off the switches 342 and 352 respectively thereby power off the 1394 controller 340 and the ESATA controller 350 for reducing power consumption. It is to be understood that although the switches 322, 332, 342 and 352, in this embodiment, are implemented by NMOS transistors, the invention is not limited thereto. In other words, the switches can be implemented by any other devices or elements with similar functionality.

In summary, compared with conventional computer systems where all controllers of peripheral devices are activated when powered up, specific controllers, according to the invention, is activated only when a corresponding peripheral device is connected to the system chip through the connector and the controller for avoiding unnecessary power consumption. Moreover, scanning of all of the peripheral devices may be performed while the computer system is being powering up or it may be performed only when a trigger event occurs.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A power saving method for use in an electronic system, wherein the electronic system comprises at least one controller respectively connected to at least one peripheral device, comprising:
detecting whether any of the peripheral devices is coupled to the respective controllers;
powering off the controller by the electronic system when no peripheral device is coupled to the respective controllers; and
updating a device configuration table and continuously detecting for next peripheral device.

2. The power saving method as claimed in claim 1, wherein the step of detecting whether any of the peripheral devices is coupled to the respective controllers is performed after the electronic system is powered up and all of the controllers are activated.

3. The power saving method as claimed in claim 1, further comprising activating a checking procedure to determine whether the peripheral device is connected to the controller before the step of detecting whether any of the peripheral devices have been connected to the respective controllers is performed.

4. The power saving method as claimed in claim 3, wherein the checking procedure is activated after a control button is pressed and a program is performed for detection.

5. The power saving method as claimed in claim 3, wherein the checking procedure is activated after a screen option is selected and a program is performed for detection.

6. The power saving method as claimed in claim 1, further comprising detecting whether any of the controllers have been switched from a turned-off state to a turned-on state before the step of detecting whether any of the peripheral devices have been connected to the respective controllers is performed.

7. The power saving method as claimed in claim 1, wherein the controller is turned off by the electronic system by sending a control signal to a switch to turn off a power supplied to the controller through a GPIO port.

8. A power saving system for determining whether a peripheral device being coupled thereto for power saving control, comprising:
a system chip, having a GPIO port;
a controller coupled to the system chip; and
a switch, wherein when the system chip detects that the controller has not connected to the peripheral device, the GPIO port sends a control signal to the switch such that the switch turns off a power supplied to the controller for power saving.

9. The power saving system as claimed in claim 8, wherein a peripheral device corresponding to the controller is activated when the peripheral device is connected to the controller.

10. The power saving system as claimed in claim 8, wherein the system chip utilizes a program within the system chip to detect the connection state of the controller and the peripheral device for detecting that the controller has not been connected to the peripheral device.

11. The power saving system as claimed in claim 8, wherein the system chip is a South-Bridge chip.
